(19) United States
(12) Patent Application Publication
(10) Pub. No.: US 2008/0225838 A1
(43) Pub. Date: Sep. 18, 2008

(54) Common Rate Matching Slot for Variable Bit Rate Services

(75) Inventors: Jussi Vesma, Turku (FI); Jani Vare, Kaarina (FI); Tommi Auranen, Turku (FI); Harri Pekonen, Raisio (FI); Pekka Talmola, Turku (FI); Jukka Henriksson, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/686,628

(22) Filed: Mar. 15, 2007

(51) Int. Cl. H04L 12/00

(52) U.S. Cl. 370/375

(57) ABSTRACT

In accordance with at least one embodiment, fixed TDM slot/frame structure and statistical multiplexing are combined. A TDM slot, which is fixed (in size and position) is reserved for a variable bit rate service such that the bit rate of the TDM slot/channel is below the average rate of the service. Such a reserved TDM slot may be referred to as a service specific slot. Since the service specific slot is reserved with a bit rate below the average rate of the service, additional capacity is reserved from a rate matching slot, which may be common for multiple services. In this rate matching slot, the capacity may be shared between services according to any suitable strategy for allotting services to portions of the rate matching slot, including, but not limited to, a statistical multiplexing algorithm.

### FIELD OF THE INVENTION

The invention relates generally to communications networks. More specifically, the invention relates to communications networks in which variable bit rate services are mapped into fixed bit rate time division multiplexed slots.

### BACKGROUND OF THE INVENTION

Digital broadband broadcast networks enable end users to receive digital content including video, audio, data, and so forth. Using a mobile terminal, a user may receive digital content over a wireless digital broadcast network.

The capacity of a wireless transmission channel, in a broadcasting system, for example, can be divided between different services by using time-division multiplexing (TDM). Each service reserves a slot in a TDM frame, which results in a fixed bit rate. The bit rate is determined by the size of the slot and the frame interval. Some services, such as a real-time video service, can have a variable bit rate.

TDM capacity has typically been reserved according to the maximum bit rate of the video service in order to guarantee that the stream always fits into the reserved slot. Most of the time, however, the reserved slots are not completely filled resulting in wasted transmission capacity.

FIG. 1 shows incompletely filled TDM slots in an example TDM slot and frame structure for four services. In the example of FIG. 1, each service reserves one time slot. Data fills only a portion of the slot, the rest of the slot is unused capacity. Unused capacity of this type is equal to the maximum minus the average bit rate of the service. (In this context, the maximum bit rate refers to the maximum average bit rate over some short interval that determines the buffering length in the transmitter. By having a longer buffer, the maximum bit rate gets closer to the average bit rate at the cost of longer end-to-end delay).

The unused capacity can be decreased by sending several services in one slot (assuming that the bit rate variations for services are independent). This, however, requires the receiver to receive other services in addition to the one that is consumed, which is an inefficient use of resources, including, but not limited to, battery power of a mobile terminal.

Improved techniques for more completely filling reserved TDM slots thereby reducing wasted transmission capacity would be advancement in the art.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one embodiment, fixed TDM slot/frame structure and statistical multiplexing are combined. A TDM slot, which is fixed (in size and position) is reserved for a variable bit rate service such that the bit rate of the TDM slot/channel is below the average rate of the service. Such a reserved TDM slot may be referred to as a service specific slot. Since the service specific slot is reserved with a bit rate below the average rate of the service, additional capacity is reserved from a rate matching slot, which may be common for multiple services. In this rate matching slot, the capacity may be shared between services according to any suitable strategy for allotting services to portions of the rate matching slot, including, but not limited to, a statistical multiplexing algorithm.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 shows incompletely filled Time Division Multiplexed (TDM) slots in an exemplary TDM slot and frame structure.

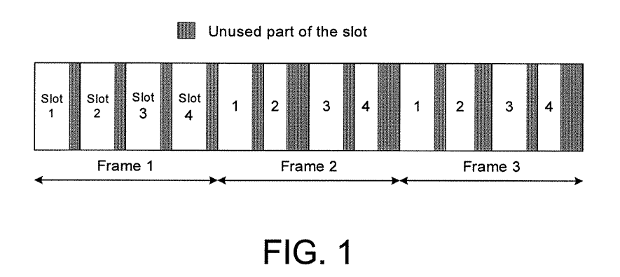

FIG. 2 illustrates schematically a suitable digital broadband broadcast system in which one or more illustrative embodiments of the invention may be implemented.

FIG. 3 illustrates an example of a mobile device in accordance with an aspect of the present invention.

FIG. 4 illustrates schematically an example of cells, each of which may be covered by a different transmitter in accordance with an aspect of the present invention.

FIG. 5 illustrates the OSI reference model as containing seven layers.

FIG. 6 is a schematic diagram that shows an example of overflow data from service specific slots in rate matching slots in accordance with an aspect of the invention.

FIG. 7 shows an exemplary framing structure, including unused parts, of a TDM slot in accordance with an aspect of the invention.

FIG. 8 shows an exemplary framing structure of a TDM slot in accordance with an aspect of the invention.

FIG. 9 shows an example of data for services mapped to one or more subcarriers in one or more radio frequency channels in accordance with an aspect of the invention.

FIG. 10 shows an exemplary framing structure including a rate matching slot for a TDM slot in accordance with an aspect of the invention.

FIG. 11 is a schematic diagram showing an example of mapping services into physical channels in accordance with an aspect of the invention.

FIG. 12 is a schematic diagram showing an example of how TDM slots may be formed in a modulator in accordance with an aspect of the invention.

FIG. 13 is a flow chart showing steps for forming a TDM frame and slots in accordance with an aspect of the invention.

FIG. 14 illustrates an exemplary structure of a data stream protocol packet, in accordance with one or more aspects of the invention.

FIG. 15 is a flow chart showing steps for receiving data stream protocol packets in accordance with one or more aspects of the invention.

FIG. 16 shows steps performed by a receiver in accordance with an aspect of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

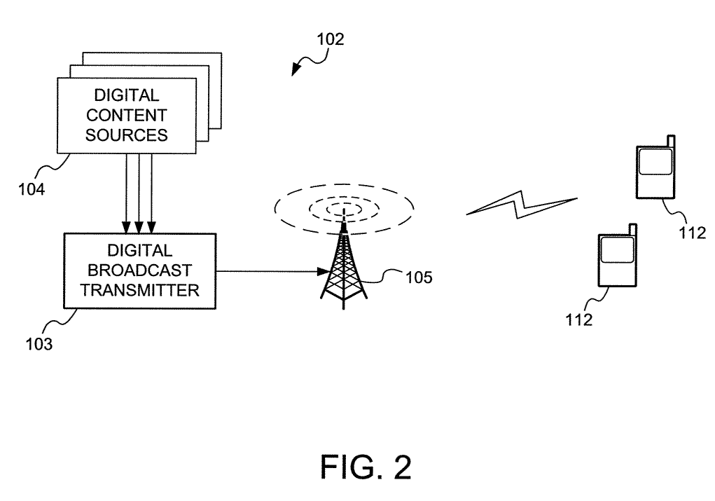

FIG. 2 illustrates a suitable digital broadband broadcast system 102 in which one or more illustrative embodiments may be implemented. Systems such as the one illustrated here may utilize a digital broadband broadcast technology, for example Digital Video Broadcast-Handheld (DVB-H) or next generation DVB-H networks. Examples of other digital broadcast standards which digital broadband broadcast system 102 may utilize include Digital Video Broadcast-Terrestrial (DVB-T), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Satellite Digital Multimedia Broadcasting (S-DMB), Forward Link Only (FLO), Digital Audio Broadcasting (DAB), and Digital Radio Mondiale (DRM). Other digital broadcasting standards and techniques, now known or later developed, may also be used. Aspects of the invention may also be applicable to other multicarrier digital broadcast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

Digital content may be created and/or provided by digital content sources 104 and may include video signals, audio signals, data, and so forth. Digital content sources 104 may provide content to digital broadcast transmitter 103 in the form of digital packets, e.g., Internet Protocol (IP) packets. A group of related IP packets sharing a certain unique IP address or other source identifier is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission component) for wireless transmission. Ultimately, mobile terminals or devices 112 may selectively receive and consume digital content originating from digital content sources 104.

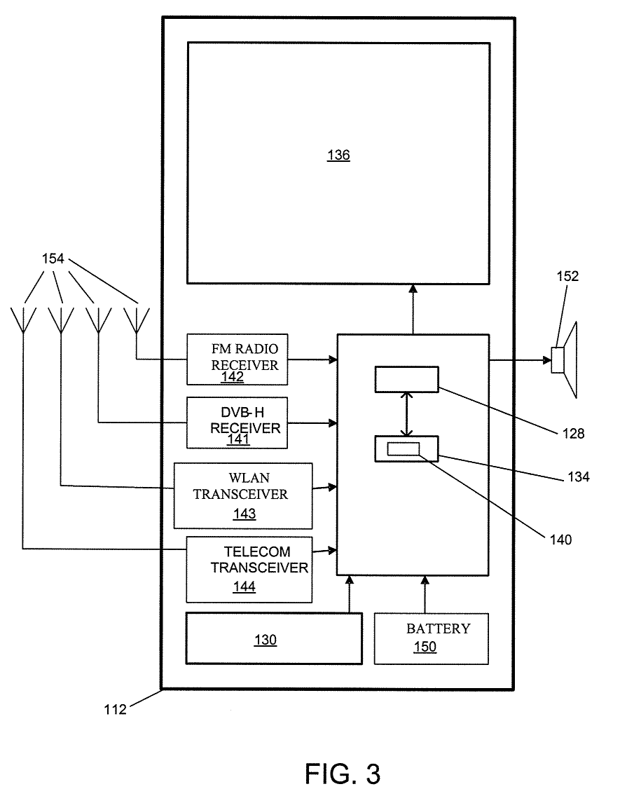

As shown in FIG. 3, mobile device 112 may include processor 128 connected to user interface 130, memory 134 and/or other storage, and display 136, which may be used for displaying video content, service guide information, and the like to a mobile-device user. Mobile device 112 may also include battery 150, speaker 152 and antennas 154. User interface 130 may further include a keypad, touch screen, voice interface, one or more arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H or DVB-T through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-Satellite (DVB-S), or DVB-Terrestrial (DVB-T). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing entails sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

In addition, an electronic service guide may be used to provide program or service related information. Generally, an Electronic Service Guide (ESG) enables a terminal to communicate what services are available to end users and how the services may be accessed. The ESG includes independently existing pieces of ESG fragments. Traditionally, ESG fragments include XML and/or binary documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data including the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One type of DVB is Digital Video Broadcasting-Handheld (DVB-H). The DVB-H is designed to deliver 10 Mbps of data to a battery-powered terminal device.

DVB transport streams deliver compressed audio and video and data to a user via third party delivery networks. Moving Picture Expert Group (MPEG) has defined a technology by which encoded video, audio, and data within a single program or service is multiplexed, with other programs, into a transport stream (TS). The TS is a packetized data stream, with fixed length packets, including a header. The individual elements of a service, audio and video, are each carried within packets having a packet identification (PID) that may be unique for the service or to the components of the service. To enable a receiver device to locate the different programs and elements of a particular program within the TS, Program Specific Information (PSI) and Service Information (SI), which are embedded into the TS, are supplied. PSI/SI enables a receiver device to correctly process the data contained within the TS.

As stated above, the ESG fragments may be transported by IPDC over a network, such as for example, DVB-H to destination devices. DVB-H network may be used to transmit for example audio, video, and data streams. The destination device then determines the ordering of the ESG fragments and assembles them into useful information.

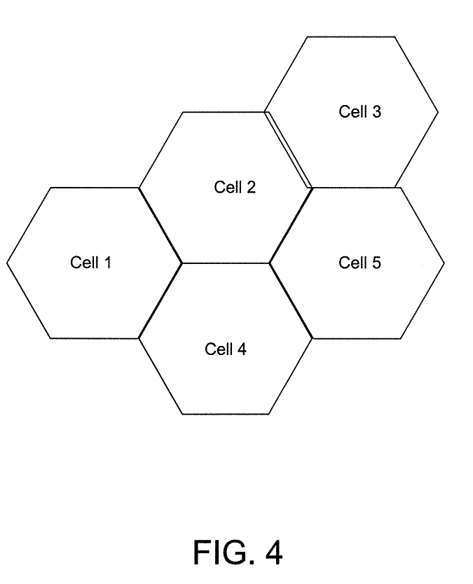

In a typical communication system, a cell may define a geographical area that may be covered by a transmitter or group of transmitters. The cell may be of any size and may have neighboring cells. FIG. 4 illustrates schematically an example of cells, each of which may be covered by a different transmitter. In this example, Cell 1 represents a geographical area that is covered by a transmitter for a communication network. Cell 2 is next to Cell 1 and represents a second geographical area that may be covered by a different transmitter. Cell 2 may, for example, be a different cell within the same network as Cell 1. Alternatively, Cell 2 may be in a network different from that of Cell 1. Cells 1, 3, 4, and 5 are neighboring cells of Cell 2, in this example.

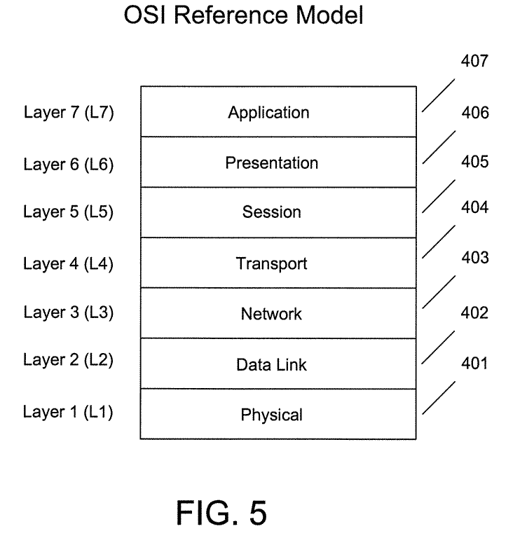

Communication between network components may be accomplished via the Open Systems Interconnection (OSI) standard. The OSI framework of the process for communication between different network components may be structured as seven layers or categories as described by the OSI reference model. FIG. 5 illustrates the OSI reference model as containing seven layers. Typically, layers 4-7 pertain to end-to-end communications between message source and message destination and layers 1-3 pertain to network access. Layer 1 (401, the physical layer) deals with the physical means of sending data over lines. This may include, for example, electrical, mechanical or functional control of data circuits. Layer 2 (402, the data link layer) pertains to procedures and protocols for operating communication lines. Also, detection and correction of message errors may be accomplished in Layer 2. Layer 3 (403, network layer) determines how data is transferred between different network components. Also, Layer 3 (403) may address routing in networks. Layer 4 (404, Transport layer) pertains to defining rules for information exchange. Layer 4 (404) may also be involved in the end-to-end delivery of information within and between networks. This information may further include error recovery and flow control. Layer 5 (405, Session layer) pertains to dialog management in Layer 5 (405) and may control use of basic communications facilities provided by Layer 4 (404, transport layer). Layer 6 (406, presentation layer) pertains to providing compatible interactivity between data formats. Layer 7 (407, application layer) provides functions for particular applications services. These functions may include file transfer, remote file access and/or virtual terminals.

Statistical multiplexing generally deals with sharing fixed capacity among variable bit rate streams. It usually schedules data packets in such a way that they appear in the stream in random places. If statistical multiplexing of TDM slots was performed, it would prevent switching off digital broadcast receiver for power saving, because the location of the next slot would be unknown.

In accordance with at least one embodiment, fixed TDM slot/frame structure and statistical multiplexing are combined. A TDM slot, which is fixed (in size and position) is reserved for a variable bit rate service such that the bit rate of the TDM slot/channel is below the average rate of the service. Such a reserved TDM slot may be referred to as a service specific slot.

Since the service specific slot is reserved with a bit rate below the average rate of the service, additional capacity is reserved from a rate matching slot, which may be common for multiple services. In this rate matching slot, the capacity may be shared between services according to any suitable strategy for allotting services to portions of the rate matching slot, including, but not limited to, a statistical multiplexing algorithm.

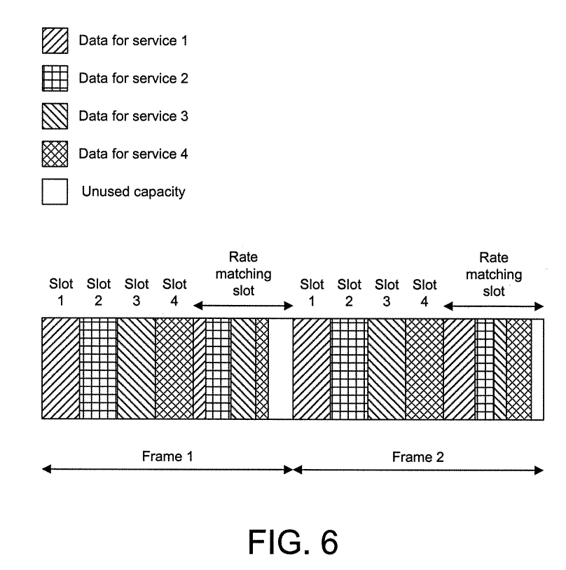

FIG. 6 is a schematic diagram that shows an example of overflow data from service specific slots in rate matching slots in accordance with an aspect of the invention. In the example of FIG. 6, the service specific slots, slots 1-4, are fully used by data for services 1-4 in frames 1 and 2, and unused capacity is collected into the rate matching slots of frames 1 and 2.

In this way, it likely that the service specific slots will be fully utilized (or substantially fully utilized). Any unused capacity is collected into the rate matching slots. The amount of unused capacity will typically be smaller as compared to the case where the services are mapped into dedicated slots only without using common rate matching slots. This happens because the averaging of the bit rates of the services is now done over multiple services resulting in a lower bit rate variation and thus making it possible to reserve less extra capacity. It is still possible to further reduce the bit rate variation by using transmitter buffering.

Using rate matching slots, in accordance with an aspect of the invention, facilitates utilization of the unused capacity because the unused capacity is not scattered among multiple slots. Instead, the unused capacity is in one specific slot, the rate matching slot. In accordance with an aspect of the invention, the unused capacity may be allocated to one or more non-real time best-effort services.

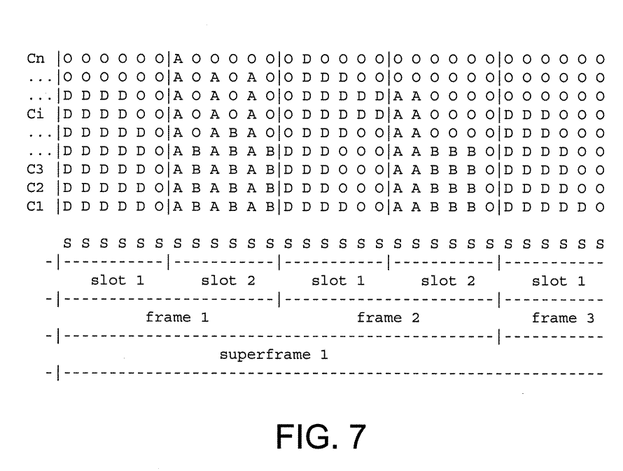

FIG. 7 shows an exemplary framing structure, including unused parts, of a TDM slot in accordance with an aspect of the invention. In the simplified example of FIG. 7, each symbol (represented by respective vertical columns labeled with the letter “S” in FIG. 7) comprises n subcarriers (C1, . . . ,Ci, . . . ,Cn), each of which may carry data (A, B, D) or may not carry data (as indicated in FIG. 7 by the letter O). Any particular slot may carry data from one or more services (A, B, D). In the example of FIG. 7, slot 1 of frame 1 carries data from service D, and slot 2 of frame 1 carries data from services A and B. It is not necessary to map services to subcarriers. For example, all subcarriers from slot 2 may contain data for service A and B.

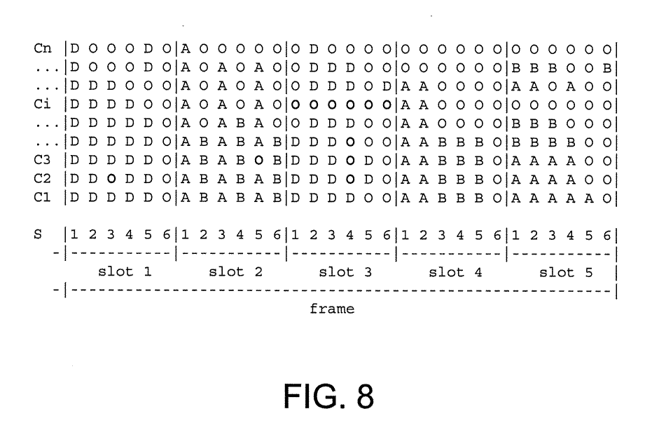

FIG. 8 shows an exemplary framing structure of a TDM slot in accordance with an aspect of the invention. In the example of FIG. 8, slot 1 illustrates a case in which the slot carries data from only one service D. In this slot, any symbol sent on a subcarrier may, or may not, carry data for that service. In FIG. 8, symbols are represented as vertical columns that are labeled 1-6 within each slot. If a symbol is not carrying data for the service, the carrier may be unmodulated or may carry a predetermined data value. In different embodiments, such a predetermined data value may be “all zeroes” or “all ones” or any other value may be chosen so that the value will be mixed to a valid data value. The symbols carrying no data may be in any position in the slot. For example, symbol 3 on carrier C2 does not carry data for the service, although the adjacent symbols on the same and adjacent carriers carry data for the service. In a further embodiment, one or more whole slots within a frame may be not carrying data at all and, in a similar way, one or more frames in a superframe may be left empty.

Slot 2 illustrates a case where data from two services is multiplexed into one slot. Data for services A and B are mapped to the carriers so that they alternate in the time dimension (i.e., symbol numbering). The alternating pattern may take various forms such that data for service A is mapped to two (or more) consecutive symbol positions, and data for service B is mapped to next two (or more) symbol positions. The pattern may, in some embodiments, be different for different subcarriers. Also, in this embodiment, symbols not carrying data for either service may be in any position within the slot. In some embodiments, more than two services may be multiplexed into a single slot.

Slot 3 illustrates a case in which symbols not carrying data (as indicated by an O in FIG. 8) may be positioned in between symbols carrying data for the service. One or more subcarriers, such as subcarrier Ci, may carry no data for a service.

Slot 4 illustrates a case in which data from two services is multiplexed into one slot so that the data for the first service, service A, occupies selected first symbol positions, and data for the second service, service B, occupies next consecutive symbol positions on each subcarrier.

Slot 5 illustrates a further case in which data from two (or more) services is multiplexed into one slot such that each subcarrier that carries data does so for only one service. In this case, an empty symbol, O, may appear at any position within the slot.

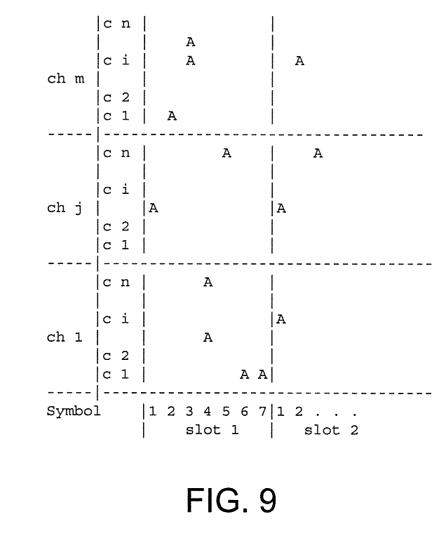

In the examples of FIGS. 7 and 8, the data for the services is mapped to one or more subcarriers in one radio frequency channel. In further embodiments, the data for the services may be mapped to one or more subcarriers (c1, . . . , ci, . . . , cn) in one or more radio frequency channels (ch 1, . . . , ch j, . . . , ch m) as is schematically shown in FIG. 9. In this example, data for service A is sent using three different radio frequency channels that are chosen among the available radio frequency channels. The data in other symbol positions may be from other services that are mapped in a similar way, or some of the symbol positions carry no data for services, as in previous examples. Service data from service A is allocated to different radio channels such that, during one symbol time, data for the same service A is transmitted on one radio channel only. For the receiver to cope with radio channel hopping when changing, for example, from channel 1 to channel j, there would be at least one symbol during which the change is made. In a similar way slots could be allocated, i.e., service A would be transmitted during slot 1 on channel 1, during the next slot on channel j, and so on. In one embodiment, such channel changes could be synchronized to pilot and/or synchronization symbols that are placed at the beginning of each frame and also within frames repeatedly, for example, every 50 ms.

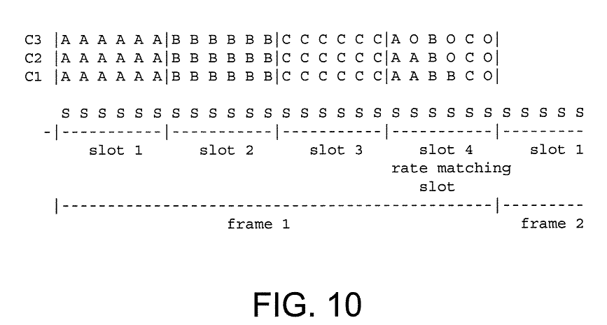

FIG. 10 shows an example framing structure including a rate matching slot for a TDM slot in accordance with an aspect of the invention. In the example of FIG. 10, slots 1, 2, and 3 carry data for services A, B, and C, respectively. Slot 4, which is a rate matching slot, carries data for services A, B, and C and includes subcarriers and a symbol that do not carry any data (as indicated by the O's).

In accordance with embodiments that include rate matching slots, the receiver stays on to receive data from the service specific slot and from the common rate matching slot. This may increase the power consumption of the receiver. To address that situation, one or more of the following techniques may be used. The service specific slot may include information configured to specify whether the rate matching slot includes data from one or more particular services. The beginning of the rate matching slot may signal what services it carries, which would enable a receiver to check only the selected signals, as opposed to receive the whole slot. If a system contains some type of block Forward Error Correction (FEC) like Multi-Protocol Encapsulation FEC (MPE-FEC), FEC, or part of FEC, could be transmitted in the common rate matching slot. Then, if a receiver detects that it received slot 3 Service C without errors, it does not need to receive the common rate matching slot. Services for which power saving is more difficult to achieve (e.g. low bit rate services) may be placed adjacent to the rate matching slot requiring only one switch on and synchronization per frame. Services may be placed relative to one another in the common rate matching slot such that they are located closely to corresponding service-specific slots. For example, with reference to FIG. 10, C services within the rate matching slot may be located first, B second, and A last. Then, slot 3, which contains service C, and C service from the rate matching slot 4 would be close to each other. Similarly, service A from the rate matching slot 4 would be close to frame 2, slot 1, containing service A.

TDM systems enable using slot specific (or service specific) modulation and code rate (CR). However, these parameters will typically be the same for services within the rate matching slot. Therefore, the service data may be set using different CR and modulation depending on whether the data is sent in a service specific slot or a common rate matching slot. If there are different QoS classes (i.e., services with different modulation and code rate), respective rate matching slots may be used for each QoS class. Further, to distinguish between various services for which data is carried in a rate matching slot, any suitable identification strategy may be used, including, but not limited to, at least one of a service identifier and a physical channel identifier being carried in the headers of data packets, for example.

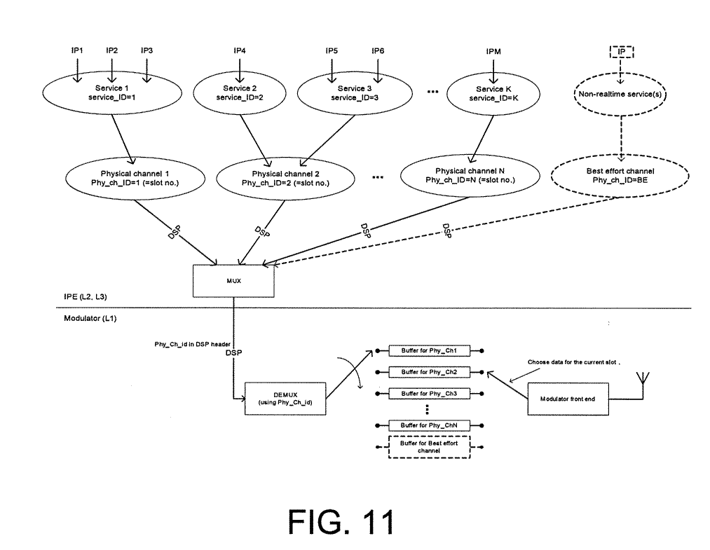

FIG. 6 is simplified in the sense that one service is directly mapped into one slot without using the concept of a physical channel. However, in FIG. 11, physical channels, not services, are mapped into slots.

FIG. 11 is a schematic diagram showing an example of mapping services into physical channels in accordance with an aspect of the invention. One physical channel can carry one or more services. A physical channel may reserve one slot in a TDM frame. A non-realtime service may utilize the unused capacity in the common rate matching slot. In addition, such a service may have its own slot in order to achieve a minimum bit rate.

FIG. 11 shows an example of how services may comprise one or more IP streams, physical channels may carry one or more services, a physical channel may reserve one slot from a TDM frame, each physical channel may have its own data buffer in the modulator, service specific slots and rate matching slots are formed by reading data from the buffers, and an optional best effort channel may use otherwise unused capacity of the rate matching slot.

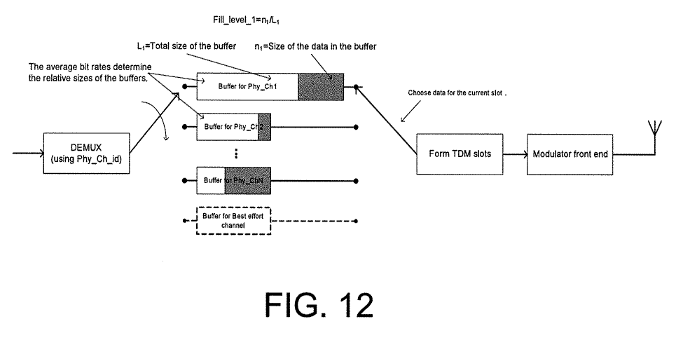

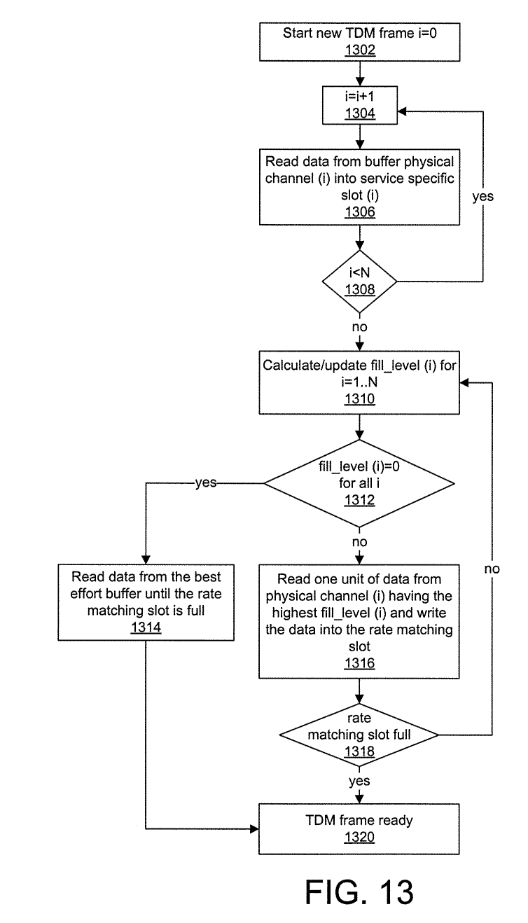

FIG. 12 is a schematic diagram showing an example of how TDM slots may be formed in a modulator in accordance with an aspect of the invention. In the example of FIG. 12, the buffers for physical channels 1, 2, and N have different respective sizes. The size of these buffers may be determined based on the respective average bit rates of the physical channels in accordance with an apportionment strategy for the common rate matching slot, such as the statistical multiplexing algorithm of FIG. 13. For example, the buffer size for physical channel 1 is double the size of that for physical channel 2, meaning that the bit rate of physical channel 1 is twice the bit rate of physical channel 2.

FIG. 13 is a flow chart showing steps for forming a TDM frame and slots in accordance with an aspect of the invention. In the upper part (i.e., steps 1302-1308), data is written in the service specific slots, whereas, in the lower part (i.e., steps 1310-1320), statistical multiplexing is used to fill the common rate matching slot. Statistical multiplexing, in this example, reads data from the buffer that is most full on a percentage basis of buffer size. As will be apparent other suitable strategies for filling the rate matching slot may also be used.

A Data Stream Protocol (DSP), in accordance with at least one aspect of the invention, allows different types of data to be carried within fixed length data stream (DS) packets.

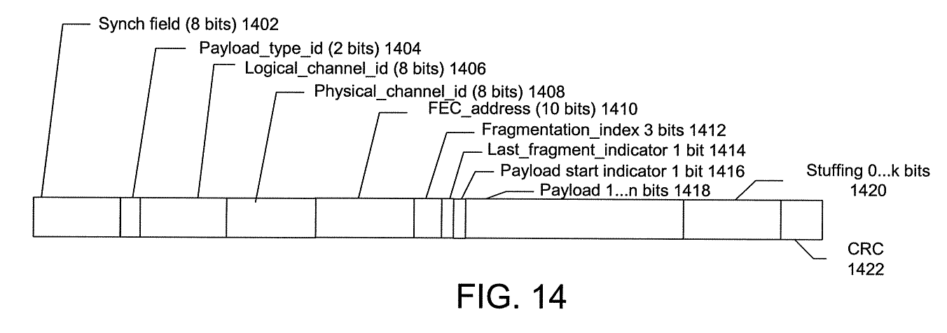

FIG. 14 illustrates an exemplary structure of a DSP packet, in accordance with one or more aspects of the invention.

Synchronization field 1402 enables detection of the beginning of each DSP packet within a receiver and a network. In accordance with at least one aspect of the invention, synchronization field contains 8 bits. As is the case with other fields and parameters disclosed herein having a particular number of bits, the synchronization field may contain any other suitable number of bits.

Payload type identifier 1404 (e.g., payload_type_id) may be used for identifying the payload type encapsulated within the payload. For example, payload type identifier may specify a payload type including, but not limited service discovery descriptor, (SDD), neighboring service discovery descriptor (NSDD), Internet Protocol (IP), Reed-Solomon (RS) and the like.

Logical channel identifier 1406 (e.g., logical_channel_id) may be used for identifying a logical channel of an associated packet. This identifier may be used by a receiver for discovering the packets part of specific logical channel when there are packets from more than one logical channel available within a particular slot.

Physical channel identifier 1408 (e.g., physical_channel_id) may be used for identifying a physical channel in which an associated DS packet is carried. A physical channel identifier enables a network element to allocate DSP packets into correct physical channels.

Forward Error Correction address 1410 (e.g., FEC_address) may be used for mapping DS packets carrying application data with corresponding DS packets carrying RS data when FEC is used. If FEC is not used, this field can be ignored.

Fragmentation index 1412 (e.g., Fragmentation_index) is a counter for the payload fragments encapsulated within DSP packets. Fragmentation index 1412 enables a receiver to decapsulate the payload in the correct order, e.g., in case some of the packets are lost.

Last fragment indicator 1414 (e.g., last_fragment_indicator) may be used for indicating a last fragment of an encapsulated payload.

Payload start indicator 1416 (e.g., Payload_start_indicator) may be used for indicating whether a current DSP packet carries the first fragment of an encapsulated payload. Payload 1516 is the payload of a DSP packet.

Stuffing 1420 are bits that may be added if a packet is not full. And Cyclic Redundancy Check (CRC) 1522 is a well known way for checking that a received block of data is free from errors.

In accordance with at least one aspect of the invention, DSP packets have a fixed size. The size of the packet may be determined based on an error correction code, the length of the interleaver, and the length of a symbol.

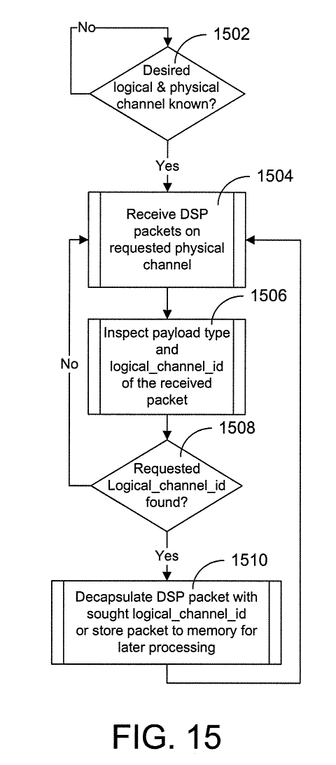

FIG. 15 is a flow chart showing steps for receiving DSP packets in case of IP and Reed-Solomon (RS) data in accordance with one or more aspects of the invention.

A determination is made, as shown at 1502, with respect to whether a desired logical and physical channel is known. If they are not known, then the “no” branch from 1502 loops back to 1502 until they are known. Otherwise, if the desired logical and physical channel are known, then the yes branch from 1502 is followed.

DSP packets are received on the requested physical channel as shown at 1504. The payload type and the logical channel identifier of the received packet are inspected, as shown at 1506. A determination is then made, as shown at 1508, with respect to whether the requested logical channel has been found. If the requested logical channel has not been found, the “no” branch from 1508 will be followed to 1504. Otherwise, if the requested logical channel has been found, then the “yes” branch from 1508 will be followed. The DSP packet with the selected logical channel identifier will then be decapsulated, or the packet may be stored to memory for later processing, as shown at 1510. Processing then loops back to 1504. The fragmentation index and/or the last fragment indicator may be used to ensure that payload is decapsulated in an appropriate order.

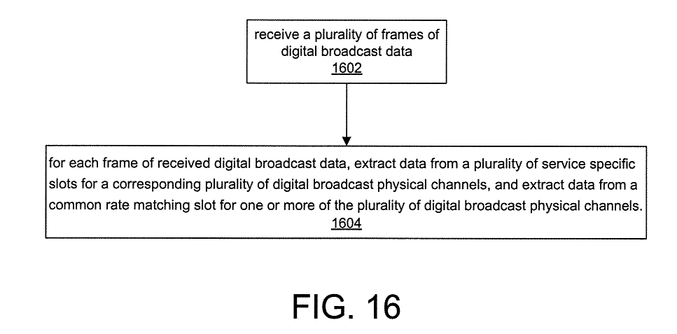

FIG. 16 shows steps performed by a receiver in accordance with an aspect of the invention. A plurality of frames of digital broadcast data is received, as shown at 1602. For each frame of received digital broadcast data, data is extracted from a plurality of service specific slots for a corresponding plurality of digital broadcast physical channels, and data is extracted from a common rate matching slot for one or more of the plurality of digital broadcast physical channels, as shown at 1604.

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), application specific integrated circuits (ASIC) and the like.

Embodiments of the invention include any novel feature or combination of features disclosed herein either explicitly or any generalization thereof. While embodiments of the invention have been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A method comprising:
reading digital broadcast data from a plurality of buffers for a corresponding plurality of physical channels;
inserting the digital broadcast data into a plurality of service specific slots of a frame of time division multiplexed digital broadcast data;
determining how full each of the plurality of buffers is relative to each buffer's respective capacity;
reading digital broadcast data from a fullest buffer of the plurality of buffers;
inserting the digital broadcast data read from the fullest buffer into a common rate matching slot of the frame of time division multiplexed digital broadcast data; and
repeating the determining, the reading from the fullest buffer, and the inserting from the fullest buffer steps until the rate matching slot is full.

2. The method of claim 1, wherein the service specific slots have bit rates that are below the respective bit rates of the physical channels that correspond to the respective service specific slots.

3. The method of claim 1, wherein each of the plurality of buffers has a respective size that is based on a bit rate of each respective physical channel of the plurality of physical channels.

4. The method of claim 1, further comprising: if each of the plurality of buffers is empty, reading data from a best effort buffer and inserting the data read from the best effort buffer into the common rate matching slot until the common rate matching slot is full.

5. The method of claim 1, wherein data for a first physical channel occupies a first one or more symbol positions within the common rate matching slot and data for a second physical channel occupies a second one or more consecutive symbol positions.

6. The method of claim 1, wherein data for a plurality of physical channels in the common rate matching slot is mapped to one or more subcarriers in one or more radio frequency channels.

7. An apparatus comprising:
a digital broadcast transmitter having a computer readable medium that contains computer executable instructions for causing the digital broadcast transmitter to perform operations comprising:
reading digital broadcast data from a plurality of buffers for a corresponding plurality of physical channels;
inserting the digital broadcast data into a plurality of service specific slots of a frame of time division multiplexed digital broadcast data;
determining how full each of the plurality of buffers is relative to each buffer's respective capacity;
reading digital broadcast data from a fullest buffer of the plurality of buffers;
inserting the digital broadcast data read from the fullest buffer into a common rate matching slot of the frame of time division multiplexed digital broadcast data; and
repeating the determine, read from the fullest buffer, and insert from the fullest buffer operations until the rate matching slot is full.

8. The apparatus of claim 7, wherein the service specific slots have bit rates that are below the respective bit rates of the physical channels that correspond to the respective service specific slots.

9. The apparatus of claim 7, wherein each of the plurality of buffers has a respective size that is based on a bit rate of each respective physical channel of the plurality of physical channels.

10. The apparatus of claim 7, wherein the computer readable medium contains further computer executable instructions for causing the digital broadcast transmitter to perform operations comprising: if each of the plurality of buffers is empty, reading data from a best effort buffer and insert the data read from the best effort buffer into the common rate matching slot until the common rate matching slot is full.

11. The apparatus of claim 7, wherein data for a first physical channel occupies a first one or more symbol positions within the common rate matching slot and data for a second physical channel occupies a second one or more consecutive symbol positions.

12. The apparatus of claim 7, wherein data for a plurality of physical channels in the common rate matching slot is mapped to one or more subcarriers in one or more radio frequency channels.

13. A method comprising:
receiving a plurality of frames of digital broadcast data; and
for each frame of received digital broadcast data,
extracting data from a plurality of service specific slots for a corresponding plurality of digital broadcast physical channels, and
extracting data from a common rate matching slot for one or more of the plurality of digital broadcast physical channels.

14. The method of claim 13, wherein the service specific slots have bit rates that are below the respective bit rates of the physical channels that correspond to the respective service specific slots.

15. The method of claim 13, further comprising extracting from the service specific slots information indicating whether the common rate matching slot contains data corresponding to particular service specific slots.

16. The method of claim 13, further comprising extracting data from the common rate matching slot for a best effort digital broadcast physical channel.

17. The method of claim 13, further comprising extracting from the common rate matching slot information indicating for which service specific slots the common rate matching slot contains data.

18. An apparatus comprising:
a digital broadcast receiver having a computer readable medium that contains computer executable instructions for causing the digital broadcast receiver to perform operations comprising:
receiving a plurality of frames of digital broadcast data, and
for each frame of received digital broadcast data,
extracting data from a plurality of service specific slots for a corresponding plurality of digital broadcast physical channels, and
extracting data from a common rate matching slot for one or more of the plurality of digital broadcast physical channels.

19. The apparatus of claim 18, wherein the service specific slots have bit rates that are below the respective bit rates of the physical channels that correspond to the respective service specific slots.

20. The apparatus of claim 18, wherein the computer readable medium contains further computer executable instructions for causing the digital broadcast receiver to perform operations comprising: extracting from the service specific slots information indicating whether the common rate matching slot contains data corresponding to particular service specific slots.

21. The apparatus of claim 18, wherein the computer readable medium contains further computer executable instructions for causing the digital broadcast receiver to perform operations comprising: extracting data from the common rate matching slot for a best effort digital broadcast physical channel.

22. The apparatus of claim 18, wherein the computer readable medium contains further computer executable instructions for causing the digital broadcast receiver to perform operations comprising: extracting from the common rate matching slot information indicating for which service specific slots the common rate matching slot contains data.

23. A system comprising:
a digital broadcast transmitter having a first computer readable medium that contains computer executable instructions for causing the digital broadcast transmitter to perform operations comprising:
inserting digital broadcast data for a plurality of physical channels into a plurality of service specific slots of a frame of time division multiplexed digital broadcast data, and
inserting digital broadcast data into a common rate matching slot of the frame of time division multiplexed digital broadcast data; and
a digital broadcast receiver having a second computer readable medium that contains computer executable instructions for causing the digital broadcast receiver to perform operations comprising:
extracting data from the plurality of service specific slots for the corresponding plurality of digital broadcast physical channels, and
extracting data from the common rate matching slot for one or more of the plurality of digital broadcast physical channels.

24. The system of claim 23, wherein the service specific slots have bit rates that are below the respective bit rates of the physical channels that correspond to the respective service specific slots.

25. The system of claim 23, wherein the first computer readable medium contains further computer executable instructions for causing the digital broadcast transmitter to perform operations comprising: inserting data read from a best effort buffer into the common rate matching slot until the common rate matching slot is full.

26. The system of claim 23, wherein data for a first physical channel occupies a first one or more symbol positions within the common rate matching slot and data for a second physical channel occupies a second one or more consecutive symbol positions.

27. The system of claim 23, wherein data for a plurality of physical channels in the common rate matching slot is mapped to one or more subcarriers in one or more radio frequency channels.

28. The system of claim 23, wherein the second computer readable medium contains further computer executable instructions for causing the digital broadcast receiver to perform operations comprising: extracting from the service specific slots information indicating whether the common rate matching slot contains data corresponding to particular service specific slots.

29. The system of claim 23, wherein the second computer readable medium contains further computer executable instructions for causing the digital broadcast receiver to perform operations comprising: extracting data from the common rate matching slot for a best effort digital broadcast physical channel.

30. The system of claim 23, wherein the second computer readable medium contains further computer executable instructions for causing the digital broadcast receiver to perform operations comprising: extracting from the common rate matching slot information indicating for which service specific slots the common rate matching slot contains data.
